(19) United States
(12) Patent Application Publication
(10) Pub. No.: US 2019/0147716 A1
(43) Pub. Date: May 16, 2019

(54) AUTOMATIC COVER DETECTION SYSTEM AND METHOD

(71) Applicant: Autronica Fire & Security AS, Trondheim (NO)

(72) Inventors: Ole Martin Pedersen, Trondheim (NO); Fredleif Buaas-Hansen, Stjørdal (NO); Per Johan Vannebo, Trondheim (NO)

(21) Appl. No.: 16/098,397

(22) PCT Filed: May 3, 2016
(86) PCT No.: PCT/EP2016/059910

§ 371 Date: Nov. 1, 2018

(51) Int. Cl. G08B 17/103; G08B 5/36; G08B 3/10

(52) U.S. Cl. CPC G08B 17/103; G08B 3/10; G08B 5/36

(57) ABSTRACT

An automatic cover detection system for a fire detector is provided. The system includes a fire detector top cover having an exposed surface. The system also includes a sensor assembly operatively coupled to the fire detector to detect the presence of an object in contact with or in close proximity of the fire detector top cover and at least partially covering the exposed surface of the fire detector top cover.

### BACKGROUND OF THE DISCLOSURE

The embodiments described herein generally relate to fire detectors and, more particularly, to an automatic cover detection system for a fire detector, as well as a method of automatically detecting a covered fire detector.

The ability to detect the presence of fire provides for the safety of occupants and property. In particular, because of the rapid expansion rate of a fire, it is important to detect the presence of a fire as early as possible. Fire detectors are employed to assist with early detection, but are designed to rely on exposure to a surrounding environment to function properly.

There are various reasons why a fire detector may be covered. For example, during construction of buildings and before commissioning of a fire alarm system, fire detectors are commonly covered to reduce or eliminate exposure to dust and pollution. Covering a fire detector may also be done to rapidly disable smoke or fire detection by an operable fire detector. This may be done for a number of reasons, including refurbishing a building or illegal smoking, for example. Regardless of the reason or intent for covering a fire detector, a covered detector is a common reason for the fire detector not being able to detect a fire. Typically, visual inspection of a fire detector is required to determine if the fire detector is covered. This is cumbersome, as some system installations may have over 10.000 fire detectors, for example.

### BRIEF DESCRIPTION OF THE DISCLOSURE

According to one embodiment, an automatic cover detection system for a fire detector is provided. The system includes a fire detector top cover having an exposed surface. The system also includes a sensor assembly operatively coupled to the fire detector to detect the presence of an object in contact with or in close proximity of the fire detector and at least partially covering the exposed surface of the fire detector top cover.

In addition to one or more of the features described above, or as an alternative, further embodiments may include that the sensor assembly comprises an optical sensor assembly having an electromagnetic sensor and an electromagnetic emitter.

In addition to one or more of the features described above, or as an alternative, further embodiments may include that the electromagnetic sensor comprises a photodiode receiver.

In addition to one or more of the features described above, or as an alternative, further embodiments may include that the electromagnetic emitter comprises an infrared light source.

In addition to one or more of the features described above, or as an alternative, further embodiments may include that the electromagnetic emitter comprises a light emitting diode (LED) source.

In addition to one or more of the features described above, or as an alternative, further embodiments may include that the sensor assembly comprises an audible sensor assembly.

In addition to one or more of the features described above, or as an alternative, further embodiments may include that the sensor assembly comprises a photoelectric sensor.

In addition to one or more of the features described above, or as an alternative, further embodiments may include that the fire detector is part of a fire detection system comprising a plurality of fire detectors.

In addition to one or more of the features described above, or as an alternative, further embodiments may include that each of the plurality of fire detectors includes the sensor assembly.

According to another embodiment, a method of automatically detecting a covered fire detector is provided. The method includes initiating an indicator with a transmitter of a sensor assembly operatively coupled to a fire detector. The method also includes receiving the indicator with a receiver of the sensor assembly to determine if an object is in contact with the fire detector and at least partially covering the fire detector top cover.

The method compares the received signal measured when the indicator is inactive with the received signal when the indicator is active. The difference between the two signals is used to identify when the sensor assembly is covered or partially covered.

In addition to one or more of the features described above, or as an alternative, further embodiments may include that the sensor assembly comprises an optical sensor assembly, the transmitter being an electromagnetic emitter.

In addition to one or more of the features described above, or as an alternative, further embodiments may include that the electromagnetic sensor comprises a photodiode receiver.

In addition to one or more of the features described above, or as an alternative, further embodiments may include that the electromagnetic emitter comprises an infrared light source.

In addition to one or more of the features described above, or as an alternative, further embodiments may include that the electromagnetic emitter comprises a light emitting diode (LED) source.

In addition to one or more of the features described above, or as an alternative, further embodiments may include that the sensor assembly comprises an audible sensor assembly.

In addition to one or more of the features described above, or as an alternative, further embodiments may include that the sensor assembly comprises a photoelectric sensor.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 is an elevation view of a fire detector having an automatic cover detection system, with the fire detector in an uncovered condition; and

FIG. 2 is an elevation view of the fire detector having the automatic cover detection system, with the fire detector in a covered condition.

### DETAILED DESCRIPTION OF THE DISCLOSURE

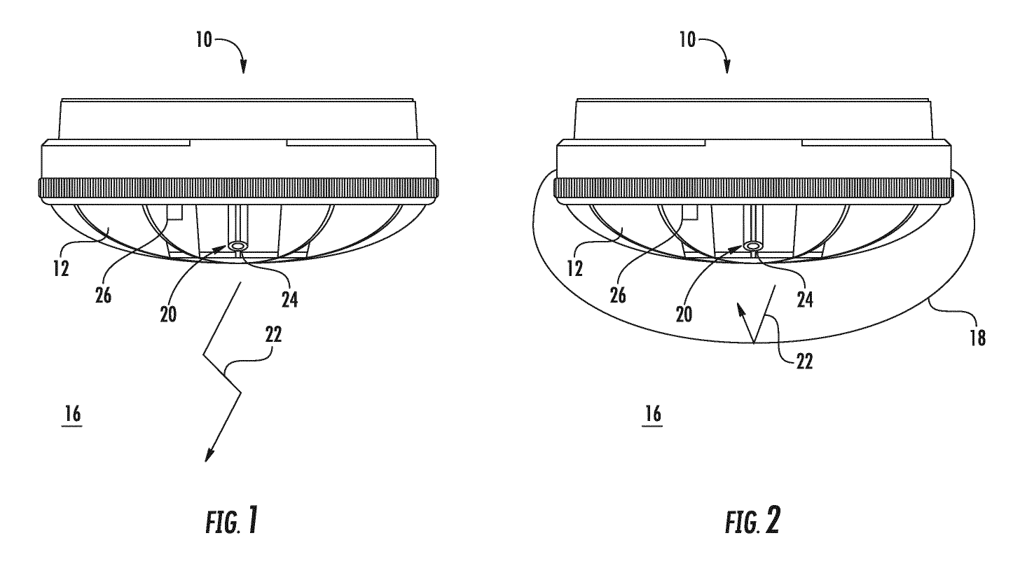

Referring to FIG. 1, a fire detector is illustrated and generally referenced with numeral 10. The fire detector 10 includes a top cover 12 that at least partially encloses internal components of the fire detector 10. The top cover 12 includes an exposed surface 14 that is an exterior surface of the top cover 12 exposed to an environment 16 that the fire detector 10 is configured to monitor. In particular, the fire detector 10 is configured to detect heat, smoke, and/or other conditions that are indicative of a safety and/or damage concern to the environment 16. The fire detector 10 may be a single detector used in a residential or commercial setting, or may be part of a safety system that includes a plurality of fire detectors. In some embodiments, such a system may include more than 20,000 fire detectors.

FIG. 1 illustrates the fire detector 10 in an uncovered condition that allows for normal and desired operation of the fire detector 10. The fire detector 10 relies on exposure to the environment 16 to carry out reliable detection operations.

FIG. 2 illustrates the fire detector 10 in a covered condition. More specifically, an object 18 is disposed in contact with the fire detector 10 and at least partially covering the exposed surface 14 of the top cover 12. In some cases, the object 18 completely encapsulates the top cover 12 or even the entire fire detector 10. Regardless of the intent of placement of the object 18 over the top cover 12, a safety issue arises when the fire detector 10 is intended to operationally detect a fire, but is in the covered condition. The term object 18, as used herein, refers to any object that is secured to the fire detector 10 in any manner that covers the top cover 12 to interfere with operation of the fire detector. This may include paint that is applied to the fire detector 10 on the exposed surface 14 which blocks airflow in a dried state.

To avoid the need for manual verification that the fire detector 10 is not in the covered condition, a sensor assembly 20 is provided to automatically detect if an object is at least partially covering the exposed surface 14 of the top cover 12. The sensor assembly 20 is operatively coupled to the fire detector 10. In some embodiments, the sensor assembly 20 is operatively coupled to the top cover 12 of the fire detector 10. Regardless of the precise location of the sensor assembly 20, an indicator 22, such as a light pulse initiated by an electromagnetic emitter to detect the presence of the object 18 if it is disposed in close proximity to the top cover 12, thereby covering the top cover 12.

In some embodiments, the sensor assembly 20 is an optical sensor assembly having an electromagnetic emitter 24 and an electromagnetic sensor 26. The electromagnetic emitter 24 is configured to initiate the indicator 22, which is an emitted light pulse or beam in FIGS. 1 and 2. The light may be selected from various suitable light sources. For example, an infrared light source may be employed to initiate the light pulse or beam. Alternatively, a light emitting diode (LED) may be utilized. These examples are merely illustrative and not limiting of light types which may be employed. In some embodiments, the electromagnetic emitter 24 (i.e., light source) is an indicator LED that is required by worldwide standards. In such an embodiment, the cost of adding the overall sensor assembly 20 is reduced based on the already-existing requirement for the indicator LED.

As shown, the light travels unimpeded away from the fire detector 10 if the top cover 12 is in the uncovered condition (FIG. 1). However, the light is interrupted by the object 18 in the covered condition (FIG. 2). The interruption by the object 18 results in reflection of the light (i.e., indicator 22). The reflection redirects the light back toward the fire detector 10, where the electromagnetic sensor 26 is located. The electromagnetic sensor 26 is configured to detect the light, and with the use of additional circuitry and/or a controller, generate an alert that the fire detector 10 is in the covered condition.

A small aperture between the emitter and the sensor may be present to allow a certain amount of emitted light to always reach the receiver. This is part of a self-verification that allows the assembly to know that it is functioning properly. This also increases the probability that paint is detected.

The alert generated by the detection of the light may be an audible alert and/or a warning message relayed to a control center, which may be referred to as Control and Indicating Equipment (CIE), that is responsible for monitoring the fire detector 10. Upon receipt of the alert, an operator is prompted to take action to halt the alert, such as by manually removing the object 18 to place the fire detector 10 in the uncovered condition.

The optical sensor assembly may be selected from a variety of optical sensors. In some embodiments, the optical sensor assembly includes a photoelectric sensor or a photodiode receiver, for example.

In some embodiments, the sensor assembly 20 comprises an audible sensor assembly that is configured to initiate a sound with a speaker or the like. A sound receiver is provided to detect at least one feature of the initiated sound, such as a decibel level or time duration of receipt of the sound, for example. Any suitable feature that is indicative of the proximity of the object 18 may be utilized to determine if the object is in contact with, or in close proximity to, the top cover 12.

In some embodiments, a mechanical switch, for instance a micro switch may be employed to detect whether the object has been added.

A method of automatically detecting the covered condition of the fire detector 10 is also provided. The method includes initiating an indicator (e.g., light, sound, etc.) with the transmitter of the sensor assembly 20 and receiving the indicator with the receiver 26 to determine if the object 18 is at least partially covering the top cover 12. The method compares the received signal measured when the indicator is inactive with the received signal when the indicator is active. The difference between the two signals is used to identify when the sensor assembly is covered or partially covered.

Advantageously, in the embodiments described above, the need for visual inspection of the fire detector 10 is eliminated based on the inclusion of the sensor assembly 20 configured to reliably detect a covered condition of the fire detector 10. This is particularly beneficial in systems that include a large number of fire detectors 10. In contrast to cumbersome and time-consuming visual inspection, automatic detection of the covered condition is provided by the sensor assembly 20. The automatic and continuous monitoring of the fire detector 10 enhances safety by immediately alerting an operator of the covered condition.

The use of the terms “a” and “an” and “the” and similar referents in the context of the present disclosure (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity). While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

1. An automatic cover detection system for a fire detector comprising:
a fire detector top cover having an exposed surface; and
a sensor assembly operatively coupled to the fire detector to detect the presence of an object in contact with or in close proximity of the fire detector top cover and at least partially covering the exposed surface of the fire detector top cover.

2. The automatic cover detection system of claim 1, wherein the sensor assembly comprises an optical sensor assembly having an electromagnetic emitter and an electromagnetic sensor.

3. The automatic cover detection system of claim 2, wherein the electromagnetic sensor comprises a photodiode receiver.

4. The automatic cover detection system of claim 2, wherein the electromagnetic emitter comprises an infrared light source.

5. The automatic cover detection system of claim 2, wherein the electromagnetic emitter comprises a light emitting diode (LED) source.

6. The automatic cover detection system of claim 1, wherein the sensor assembly comprises an audible sensor assembly.

7. The automatic cover detection system of claim 1, wherein the sensor assembly comprises a photoelectric sensor.

8. The automatic cover detection system of claim 1, wherein the fire detector is part of a fire detection system comprising a plurality of fire detectors.

9. The automatic cover detection system of claim 8, wherein each of the plurality of fire detectors includes the sensor assembly.

10. A method of automatically detecting a covered fire detector comprising:
initiating an indicator with a transmitter of a sensor assembly operatively coupled to a fire detector; and
receiving the indicator with a receiver of the sensor assembly to determine if an object is in contact with or in close proximity of the fire detector top cover and at least partially covering the fire detector top cover.

11. The method of claim 10, wherein the sensor assembly comprises an optical sensor assembly, the transmitter being an electromagnetic emitter.

12. The method of claim 10, wherein the receiver comprises a photodiode receiver.

13. The method of claim 11, wherein the electromagnetic emitter comprises an infrared light source.

14. The method of claim 11, wherein the electromagnetic emitter comprises a light emitting diode (LED) source.

15. The method of claim 10, wherein the sensor assembly comprises an audible sensor assembly.

16. The method of claim 10, wherein the sensor assembly comprises a photoelectric sensor.
